(19) United States
(12) Patent Application Publication
(10) Pub. No.: US 2019/0352133 A1
(43) Pub. Date: Nov. 21, 2019

(54) ELEVATOR CAR FOR AN ELEVATOR INSTALLATION HAVING A LINEAR MOTOR DRIVE, ELEVATOR INSTALLATION HAVING SUCH A CAR, AND METHOD FOR OPERATING AN ELEVATOR INSTALLATION

(71) Applicants: thyssenkrupp Elevator AG, Essen (DE); thyssenkrupp AG, Essen (DE)

(72) Inventors: Thomas KUCZERA, Leinfelden-Echterdingen (DE); Matthias GLÜCK, Hochdorf (DE); Markan LOVRIC, Stuttgart (DE); Michael KIRSCH, Kirchheim unter Teck (DE); Philippe GAINCHE, Grossbettlingen (DE)

(73) Assignees: thyssenkrupp Elevator AG, Essen (DE); thyssenkrupp AG, Essen (DE)

(21) Appl. No.: 16/331,318

(22) PCT Filed: Sep. 1, 2017
(86) PCT No.: PCT/EP2017/072005

§ 371 Date: Apr. 4, 2019

(30) Foreign Application Priority Data
Sep. 7, 2016 (DE) 10 2016 217 016.3

(51) Int. Cl. B66B 11/02; B66B 1/42; B66B 11/04

(52) U.S. Cl. CPC B66B 11/0273; B66B 1/42; B66B 11/0407; B66B 11/0206; B66B 11/0226

(57) ABSTRACT

An elevator car may comprise a sliding carriage for moving an elevator car along guide rails of an elevator installation designed as part of a linear motor, a receiving means disposed on the sliding carriage, and a load space with a load space floor that is supported by the receiving means. The load space may be vibration-related decoupled by way of one or more damping elements from the sliding carriage. The elevator car may also comprise a controllable actuating element disposed on the elevator car such that when activated the controllable actuating element enables a relative movement of the load space floor to the sliding carriage.

The invention relates to an elevator car for an elevator installation having a linear motor drive. Such an elevator car comprises a sliding carriage for moving the elevator car along guide rails designed as part of a linear motor. Moreover, such an elevator car comprises a receiving means arranged on the sliding carriage and a load space that is supported by the receiving means and has a load space floor. The load space here in particular is a cabin for the transporting of people.

Moreover, the invention relates to an elevator installation having such an elevator car.

Furthermore, the invention relates to a method for operating an elevator installation as well as a control system designed to carry out such a method.

Elevator installations with a linear motor drive, in which the primary part of the linear motor is provided by appropriately designed guide rails of the elevator installation and the secondary part of the linear motor is provided by the sliding carriage of the particular elevator car, which comprises the rotor of the linear motor, are known in the prior art, for example from DE 10 2010 042 144 A1 or DE 10 2014 017 357 A1.

Since in an elevator installation with a linear motor drive an elevator car can usually transport smaller loads than an elevator car in an elevator installation with a rope or belt drive, there have been efforts made to design the most weight-saving elevator cars possible in an elevator installation with a linear motor drive, especially with respect to the load space of the elevator cars. However, since oscillations and vibrations during movement of the elevator car are transmitted more strongly to the load space in such weight-reduced elevator cars, which is especially undesirable in elevator cars intended for passenger transport, efforts have been made to decouple the load space in elevator installations with a linear motor drive from the sliding carriage of the elevator car with respect to vibrations. For this purpose, it is possible to use spring damping elements in particular, which are arranged between the load space and the sliding carriage.

When using such spring damping elements, however, the new problem arises that an undesirable offset may be formed between the load space floor and the building floor bottom when such an elevator car is halted at a building floor and a payload change occurs in the load space, or an existing offset between the load space floor and the building floor bottom may be altered. In regard to the building floor bottom, the load space floor may rise up during a reduction in the payload of the load space and drop down during an increase in the payload of the load space. The offset formed or changed in this case may cause persons entering or exiting from the load space to stumble.

Against this background, one problem which the present invention proposes to solve is to make an improvement in an elevator installation with a linear motor drive and in particular to provide a solution for the above-described problem. Advantageously, a possibility should be afforded for counteracting a change in offset between the load space floor and the building floor bottom during a halting of an elevator car at a building floor.

In order to solve this problem, an elevator car, an elevator installation, a method for operating an elevator installation and a control system of an elevator installation according to the independent claims are proposed. Further advantageous embodiments of the invention are described in the dependent claims and the specification.

The proposed elevator car comprises a sliding carriage for moving the elevator car along guide rails of an elevator installation designed as part of a linear motor. Moreover, the elevator car comprises a receiving means arranged on the sliding carriage, and a load space that is supported by the receiving means and has a load space floor. The load space here is vibration-related decoupled from the sliding carriage. Furthermore, the elevator car comprises at least one controllable actuating element, which is arranged on the elevator car in such a way that when activated the at least one actuating element enables a relative movement of the load space floor to the sliding carriage or it is arranged on the elevator car in such a way that when activated the actuating element enables a relative movement of the load space floor to a service brake arranged on the sliding carriage. In particular, it is provided that the load space is manufactured in a lightweight design, in particular making use of lightweight materials such as carbon fibers.

Advantageously, the service brake is designed to be engaged with a guide rail of an elevator installation, wherein the service brake is further advantageously designed to hold the elevator car, especially also under maximum loading of the load space of the elevator car, in a fixed position relative to the guide rail. The load space of the elevator car is in particular a cabin for the transporting of people.

The sliding carriage of the elevator car advantageously comprises the rotor of the linear motor, which is formed together with the correspondingly designed guide rail of the elevator installation. In particular, it is provided that a portion of the sliding carriage forms the secondary part for a linear motor. In particular, it is provided that the sliding carriage comprises rollers with which the sliding carriage can travel along guide rails of an elevator installation. The receiving means arranged on the sliding carriage may be in particular a supporting structure or a beam on which the load space is arranged.

Thanks to the at least one actuating element, and preferably a plurality of actuating elements of the elevator car, a possibility is advantageously afforded of further moving in particular the load space floor of the elevator car even when the elevator car is secured to at least one guide rail of an elevator installation, especially when the elevator car is secured to at least one guide rail of an elevator installation by activating a service brake. Thus, advantageously, the position of the load space floor of the elevator car secured to at least one guide rail can be changed without having to release the service brake. In this way, in particular, the possibility is afforded of counteracting an offset between the building floor bottom and the load space floor when such an elevator car is halted at a building floor. In particular, thanks to the at least one actuating element of the elevator car, the possibility is furthermore advantageously afforded of adapting the position of the load space when stopping at a building floor, in particular so as to position the load space optimally in a holding position of an elevator installation. According to one advantageous embodiment of the elevator car it is provided that the at least one actuating element is arranged such and designed such that a changing of the position of the load space, and especially a changing of the position of the load space floor is possible for the elevator car secured to the at least one guide rail in the case of horizontally arranged guide rails for a horizontal travel of the elevator car and/or vertically arranged guide rails for a vertical travel of the elevator car and/or slanted guide rails for a slanted travel of the elevator car. The respective changing of position occurs advantageously by a relative movement of the load space or the load space floor to the sliding carriage of the elevator car or the service brake of the elevator car arranged on the sliding carriage. When the elevator car is used in an elevator installation, the relative movement thus occurs in this embodiment also with respect to the at least one guide rail of the elevator installation on which the elevator car is secured with the service brake activated.

In particular, it is provided that the at least one actuating element of the elevator car enables a lifting movement or a tilting movement or a lifting-tilting movement as the relative movement of the load space floor to the sliding carriage or as the relative movement of the load space floor to the service brake of the elevator car. The at least one actuating element thus enables in particular a raising and/or a lowering and/or an inclining of the load space floor, especially an inclining of the load space floor in the direction of an entrance to a building floor from the load space at a building floor stop. According to another especially advantageous embodiment, the at least one actuating element is furthermore arranged such and designed such as to incline the load space floor in the direction of movement of the elevator car in the case of a horizontal travel of the elevator car and thus to lower it by a few centimeters in the direction of movement and thereby counteract a tilting movement of persons being transported in the load space.

According to another especially advantageous embodiment of the elevator car, the elevator car comprises at least one damping element, especially at least one spring damping element, by means of which the load space is decoupled from the sliding carriage of the elevator car with respect to vibrations. The at least one damping element is advantageously arranged between the load space and the receiving means of the elevator car or the at least one damping element is arranged between the receiving means and the sliding carriage of the elevator car or at least one first damping element is arranged between the load space and the receiving means of the elevator car and at least one second damping element is arranged between the receiving means and the sliding carriage of the elevator car. By means of the at least one damping element, the load space of the elevator car is advantageously vibration-related decoupled from the sliding carriage. Advantageously vibrations caused during the travel of the elevator car along guide rails of an elevator installation are at least reduced or not transmitted at all to the load space of the elevator car.

According to one advantageous variant embodiment of the proposed elevator car, the at least one damping element and the at least one actuating element are realized by an actively adaptive damping element. Actively adaptive means in particular that, by actuating this damping element, an adaptation of the damping element to different requirements, in particular to changes in the payload of the load space of the elevator car, occurs. In particular, the spring/damping characteristic of the actively adaptive damping element can be changed, in particular, be made softer and harder. The at least one actively adaptive damping element advantageously fulfills the function of both the at least one damping element and the function of the at least one actuating element. In particular, the at least one actively adaptive damping element during a travel of the elevator car along guide rails of an elevator installation decouples the load space from the sliding carriage of the elevator car related to vibrations. Moreover, the at least one actively adaptive damping element, when the elevator car is not moving, enables a relative movement of the load space floor to the sliding carriage of the elevator car or a relative movement of the load space floor to the service brake of the elevator car arranged on the sliding carriage. In particular, it is provided that the at least one actively adaptive damping element is a magnetorheological damper (MRT damper).

On the other hand, another advantageous variant embodiment of the elevator car proposes that the at least one damping element is a passive damping element, in particular a passive spring damping element, and that the relative movement of the load space floor is made possible by at least one actuator element which is actively adjustable by actuation as the actuating element.

In particular, it is provided that the at least one actuating element and the at least one damping element are connected in series. In particular, it is provided that the at least one actuating element is arranged on top of or below the at least one damping element.

The at least one actuating element of the elevator car may be configured in various ways to enable the relative movement of the load space floor. In particular, it is provided that the at least one actuating element is adjustable in at least one of the following enumerated ways: mechanically adjustable, hydraulically adjustable, pneumatically adjustable, electrically adjustable, electromechanically adjustable.

Regarding the arrangement of the at least one actuating element, it is provided in particular that the at least one actuating element is arranged on the elevator car according to at least one of the following enumerated variants: between the sliding carriage and the receiving means, between the load space and the receiving means, between the load space floor and the load space, between a service brake arranged on the sliding carriage and the sliding carriage. That means, when using several actuating elements, combinations with respect to the aforementioned arrangement positions are also provided in particular. If the at least one actuating element is arranged between the load space floor and the load space, it is provided in particular that the at least one actuating element is arranged beneath the load space floor, while the load space floor in this case is a plate in particular, which can execute a lifting and/or a tilting movement within the load space. The load space in particular may have a closed or unclosed surface beneath the load space floor, formed by struts for example.

According to another advantageous embodiment of the elevator car, the elevator car comprises a closed-loop control device. This closed-loop control device is advantageously designed to determine an offset between the load space floor and a reference level outside the elevator car and to control the position of the load space floor by actuating the at least one actuating element so that the offset is reduced. In particular, it is provided that the position of the load space floor can be controlled by means of the closed-loop control device in such a way that the offset is at most ten millimeters. If the elevator car is employed in an elevator installation, the reference level is advantageously the floor bottom of a building floor during a stop at a building floor. In order to determine the position of the load space floor relative to the reference level, the closed-loop control device is advantageously designed to receive corresponding data signals. Preferably the closed-loop control device has appropriately configured position determining sensors.

According to one variant embodiment, the closed-loop control device may be provided by the elevator installation in which the elevator car travels.

The elevator installation further proposed to solve the problem mentioned above comprises at least one shaft, which joins together a plurality of building floors, at least one elevator car and at least one guide rail arranged in the shaft, which is designed as part of a linear motor, wherein the at least one elevator car can travel along the at least one guide rail. The at least one elevator car is an elevator car with the above described features or with combinations of the above described features. In particular, it is provided that the elevator installation comprises a plurality of guide rails.

Advantageously the elevator installation comprises a closed-loop control device, which is designed to determine an offset between the load space floor of a respective elevator car and a floor bottom of a building floor and to control the position of the load space floor by actuating the at least one actuating element of the elevator car so that the offset is reduced, in particular to an offset of at most ten millimeters. That is, in particular, that the load space floor should be positioned to within ten millimeters above the building floor bottom or it should be positioned to within ten millimeters below the building floor bottom. Preferably the closed-loop control device is designed to control the position of the load space floor free of offset to the building floor bottom. For the determining of the position of the load space floor relative to the reference level, the closed-loop control device is advantageously designed to receive corresponding data signals.

Preferably the closed-loop control device comprises appropriately configured position determining sensors.

The method further proposed for the solution of the problem mentioned at the outset, for operating an elevator installation, especially for operating an elevator installation described above, in which an elevator car or several elevator cars are moved by means of a linear motor drive along at least one guide rail between building floors, wherein an elevator car of the elevator installation comprises a sliding carriage for moving the elevator car along the at least one guide rail, a receiving means arranged on the sliding carriage, and a load space that is supported by the receiving means and has a load space floor, provides that the load space is or becomes decoupled from the sliding carriage at least during the movement of the elevator car with respect to vibrations, and that, when the elevator car stops at a building floor having a floor bottom, a service brake is activated and the elevator car is held stationary during the stop by the activated service brake on the at least one guide rail, wherein, by means of at least one actuating element of the elevator car, the load space floor is moved relative to the sliding carriage of the elevator car or a service brake arranged on the sliding carriage such that the load space floor has an offset to the building floor bottom of at most ten millimeters. Since the service brake is activated, the load space floor is thus also moved by means of the at least one actuating element relative to the at least one guide rail. This movement of the load space floor relative to the at least one guide rail occurs advantageously by virtue of corresponding actuation of the at least one actuating element and not by using the linear motor drive of the elevator installation. Advantageously, when stopping at a building floor, the linear motor drive formed from guide rails of the elevator installation and the sliding carriage of the elevator car being held is deactivated after activating the service brake.

The relative movement is in particular a lifting movement or a tilting movement or a lifting-tilting movement of the load space floor. In order to realize the relative movement of the load space floor, it is proposed in particular that the at least one actuating element engages directly with the load space floor and the load space floor is moved relative to the load space. In order to realize the relative movement of the load space floor, it is provided in particular as a further embodiment that the at least one actuating element engages directly with the load space and the load space and thus also the load space floor is moved relative to the receiving means. In order to realize the relative movement of the load space floor, it is provided in particular as a further embodiment that the at least one actuating element engages directly with the receiving means and the receiving means and thus also the load space floor is moved relative to the sliding carriage. In order to realize the relative movement of the load space floor, it is provided in particular as a further embodiment that the at least one actuating element engages directly with the sliding carriage and the sliding carriage and thus also the load space floor is moved relative to a service brake arranged on the sliding carriage, which when activated secures the elevator car with respect to the at least one guide rail. The load space in particular is a cabin designed for the transporting of people.

In particular, it is provided that the elevator car during the movement is an elevator car with the above described features or with combinations of the above described features.

Advantageously, in the method the load space is decoupled from the sliding carriage upon movement of the elevator car by actively adaptive damping elements, especially actively adaptive spring damping elements. As the actively adaptive damping elements, in particular MRT dampers (MRT: magnetorheological transducer) are provided, i.e., dampers in which a magnetorheological liquid is used, especially in order to achieve a variable damping for adapting to a changed loading/stressing of the load space floor, wherein advantageously appropriately designed sensors and electromagnets are used for a dynamic regulation of the viscosity. In particular, it is provided as a further embodiment that in the method the load space is decoupled from the sliding carriage upon movement of the elevator car by passive damping elements, in particular, by spring damping elements.

Another advantageous embodiment of the proposed method proposes that, upon halting at a building floor, and after activating the service brake before freeing up the access from the load space to the building floor by means of the at least one actuating element of the elevator car, the load space floor is moved relative to the at least one guide rail in such a way that the load space floor has an offset to the building floor bottom of at most ten millimeters. The releasing of the access from the load space to the building floor occurs here in particular by an opening of doors of the load space and of shaft doors. The benefit of this embodiment in particular is that, especially when people are getting into and/or getting out of the load space, thanks to the movement of the load space floor the offset is at most ten millimeters and this reduces the danger of people stumbling.

According to another advantageous embodiment of the method, upon halting at a building floor, and after activating the service brake before a payload change, during a payload change and after a payload change by means of the at least one actuating element of the elevator car, the load space floor is moved relative to the sliding carriage of the elevator car or a service brake arranged on the sliding carriage in such a way that the load space floor has an offset to the building floor bottom of at most ten millimeters. That is, upon halting at a building floor the actuating element advantageously reacts to a change in the payload. For example, if persons exit from the load space, the load space floor will be pushed upward on account of the spring force of the damping elements which decouple the load space from the sliding carriage with respect to vibrations. Advantageously, the at least one actuating element will counteract this by a lowering of the load space floor. If, for example, persons get into the load space, the load space floor will be pushed downward on account of the resilience of the damping elements which decouple the load space from the sliding carriage with respect to vibrations. Advantageously, the at least one actuating element will counteract this by a raising of the load space floor. Instead of a raising or a lowering of the load space floor it is provided in particular that the load space floor is tilted accordingly to maintain the maximum allowable offset, in particular in a way such that the portion of the load space floor pointing toward the building floor is substantially raised or lowered by the tilting movement.

Advantageously, during a halting at a building floor, the offset of the load space floor to the building floor bottom is held constant after activating the service brake. This has the advantage that, especially when people are getting into or getting out of the load space, the offset does not increase or decrease unexpectedly for the people. Advantageously, the offset is regulated by means of a closed-loop control device in such a way that the offset also remains constant in particular during payload changes of the load space during a building floor stop.

According to another advantageous embodiment, it is provided that during a halting at a building floor, the load space floor is held free of offset to the floor bottom after activating the service brake. Advantageously, the offset is regulated by means of a closed-loop control device, especially the aforementioned closed-loop control device, in such a way that the offset remains offset-free during the entire building floor stop. In particular, in this process at least one sensor detects the position of the load space floor in relation to the building floor bottom. The detected data in regard to this position is then transmitted to a closed-loop control device, especially a closed-loop control device of the elevator car, wherein the closed-loop control device actuates the at least one actuating element accordingly in dependence on the received position data, especially in such a way that the offset between the load space floor and the building floor bottom is at most ten millimeters, further advantageously in such a way that the offset during payload change is appropriately readjusted by actuating the at least one actuating element so that the offset remains constant. The closed-loop control device comprises, for example, a PI regulator as the regulator.

Furthermore, as the solution for the problem mentioned above, a control system of an elevator installation is proposed, especially an elevator installation as described above, wherein the control system is designed to carry out a method according to one of the embodiments described above. For this purpose, the control system advantageously comprises a closed-loop control device, which is designed to regulate an offset between the load space floor and the building floor bottom after activating a service brake and thus after securing an elevator car to a guide rail of an elevator installation, especially in such a way that the offset is at most ten millimeters. The control system is preferably decentralized in configuration. The control system advantageously comprises a plurality of control units, especially closed-loop control devices. In particular, these are programmed computer devices, especially programmed microcontroller circuits.

Further advantageous details, features and configuration details of the invention shall be explained more closely in connection with the exemplary embodiments represented in the figures, in which:

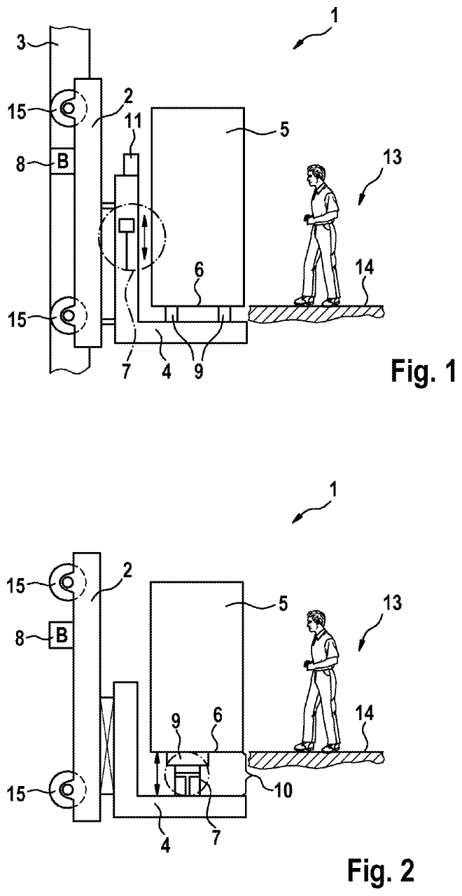

FIG. 1 in a simplified schematic representation, an exemplary embodiment of an elevator car designed according to the invention, in side view;

FIG. 2 in a simplified schematic representation, a further exemplary embodiment of an elevator car designed according to the invention, in side view;

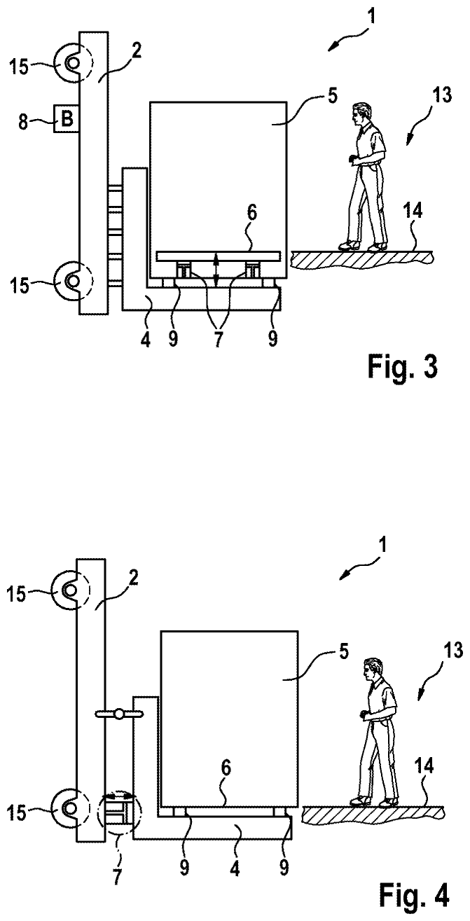

FIG. 3 in a simplified schematic representation, a further exemplary embodiment of an elevator car designed according to the invention, in side view;

FIG. 4 in a simplified schematic representation, a further exemplary embodiment of an elevator car designed according to the invention, in side view;

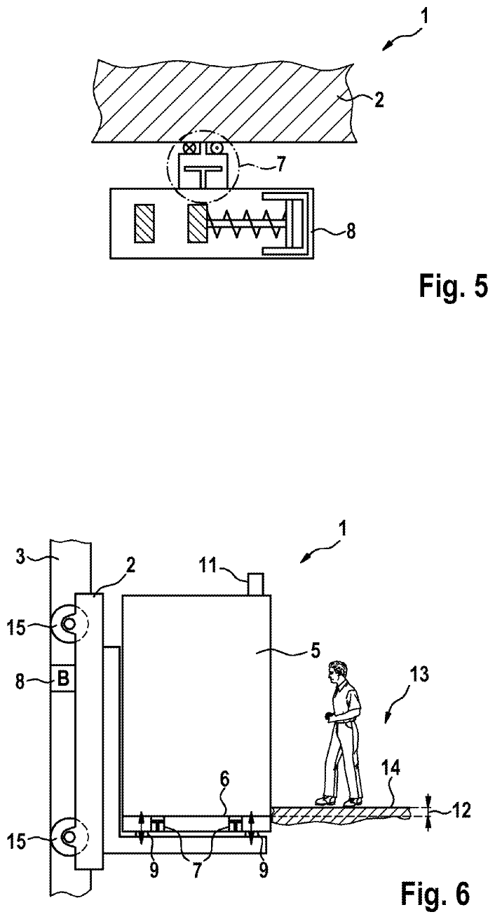

FIG. 5 in a simplified schematic representation, a further exemplary embodiment of an elevator car designed according to the invention;

FIG. 6 in a simplified schematic representation, a further exemplary embodiment of an elevator car designed according to the invention, in side view;

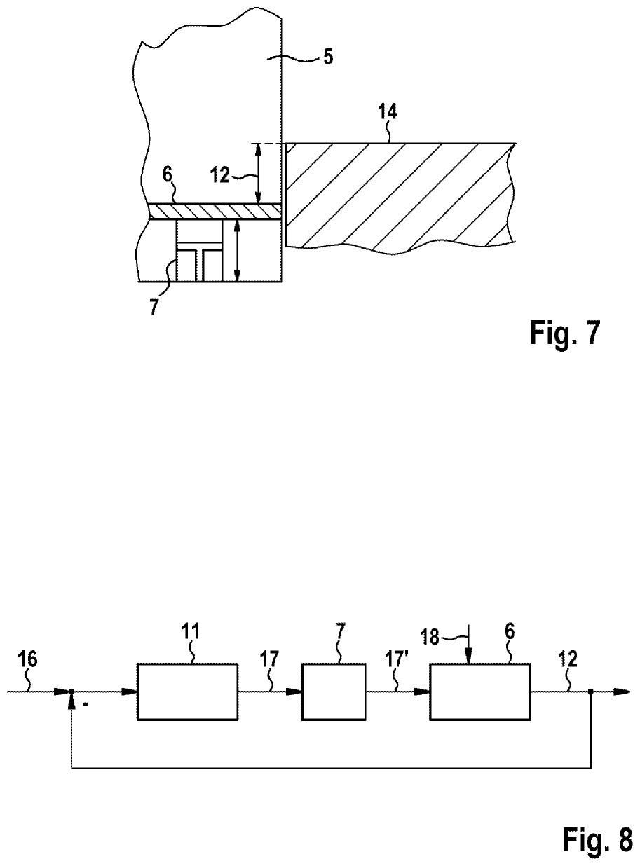

FIG. 7 in a simplified schematic representation, a cutout in enlarged representation of the exemplary embodiment shown in FIG. 6; and

FIG. 8 a block diagram for an exemplary embodiment of a closed-loop control according to the invention for the offset between the load space floor of an elevator car and a building floor bottom.

The exemplary embodiment represented in FIG. 1 shows an elevator car 1. This elevator car 1 comprises a sliding carriage 2 for moving the elevator car 1 along guide rails 3 of an elevator installation designed as part of a linear motor. The sliding carriage 2 forms together with the guide rails 3 a linear motor of the elevator installation, wherein the guide rails 3 form the primary part of the linear motor and the sliding carriage 2 forms the secondary part of the linear motor. As shown schematically in FIG. 2, it may be provided that the sliding carriage 2 comprises rollers 15 with which the sliding carriage 2 is braced against the guide rails 3. During the movement of the elevator car 1 along the guide rails 3, the rollers 15 roll along on the guide rails 3. The sliding carriage 2 moreover comprises a service brake 8, which is designed in particular to hold the elevator car 1 in a fixed position on the guide rails 3 during a stopping of the elevator car 1 at a building floor 13. The service brake 8 is advantageously dimensioned such that it holds the elevator car 1 in particular even at full load, especially also when the linear motor drive is deactivated for the elevator car 1. In a variant embodiment not shown here, the service brake may also be provided by the elevator installation.

The elevator car 1 shown as an example in FIG. 1 further comprises a receiving means 4 arranged on the sliding carriage 2, such as a holding device, and a load space 5 that is supported by the receiving means 4. The load space 5 is made of a lightweight construction, especially making use of lightweight materials like carbon. In the load space 5, the loads to be delivered by the elevator car 1 are transported. In particular, the load space 5 may be a cabin for the transporting of people. The load space 5 has a load space floor 6, which in the exemplary embodiment shown in FIG. 1 is connected fixedly to the load space 5.

Beneath the load space 5, spring damping elements 9 such as spiral springs with corresponding dampers are arranged between the receiving means 4 and the load space 5. Thanks to these spring damping elements 9, the load space 5 is vibration-related decoupled from the sliding carriage 2. Vibrations which may arise during the movement of the sliding carriage 2 along the guide rails 3 are advantageously passed on to the load space 5 in most highly reduced form by the damping elements. In this way, the ride comfort is advantageously enhanced for the persons being transported with the elevator car 1.

Moreover, the elevator car 1 represented in FIG. 1 as an exemplary embodiment comprises a controllable actuating element 7. The actuating element 7 in this exemplary embodiment is arranged on the receiving means 4 and connects the receiving means 4 movably to the sliding carriage 2. The actuating element 7 for example is constructed in the manner of a hydraulic cylinder, which is designed to perform lifting movements. The actuating element 7 is arranged in such a way that, when actuated, the receiving means 4 can be raised and lowered vertically with respect to the sliding carriage 2. In this way, the actuating element 7 furthermore enables a relative movement of the load space floor 6 to the sliding carriage 2. The actuation of the actuating element 7 in this exemplary embodiment occurs by means of a closed-loop control device 11. The closed-loop control device 11 may be designed in particular to work according to the way described with reference to FIG. 8.

If an elevator car configured according to the invention, for example an elevator car 1 as described above with reference to FIG. 1, is used in an elevator installation, it is provided during the operation of such an elevator installation that the elevator car 1 is moved in one or more shafts along guide rails 3 especially for the transporting of people between different building floors 13. In particular, the operation of such an elevator car 1 in a multiple-cabin elevator installation is also provided, especially one making possible a changing of shafts of the elevator cars.

During the operation of the elevator car 1 in an elevator installation, it is provided that the service brake 8 is activated at a building floor stop of the elevator car 1 at a building floor 13. The sliding carriage 2 of the elevator car 1 is held in this case on the guide rails 3 by the activated service brake 8. Since the sliding carriage 2 is then being held by the service brake 8, it may be provided to deactivate the linear motor drive for the elevator car 1 being held, while the service brake is activated. Due to the damping elements 9 of the elevator car, during a payload change of the load space 5 of the elevator car 1, it may be the case that the position of the load space 5 and thus the position of the load space floor 6 with respect to the receiving means 4 of the elevator car 1 and thus also with respect to the building floor bottom 14 changes.

For example, if the elevator car 1 with an empty load space 5 stops at a building floor 14 and several people, such as five people, enter the load space 5, the damping elements 9 will yield under the weight of the incoming people, so that the load space 5 and thus also the load space floor 6 will drop somewhat. This dropping is now counteracted by appropriate actuation of the actuating element 7. The actuating element 7 of the elevator car in this example raises the receiving means 4 and the load space 5 with respect to the sliding carriage 2 by a lifting movement. The actuation occurs here in such a way that in particular an offset between the load space floor 6 and the building floor bottom 14 of ten millimeters is not exceeded. Preferably, the actuating element 7 is regulated by means of the closed-loop control device 11 in such a way that the offset between the load space floor 6 and the building floor bottom 14 remains constant and preferably is less than three millimeters. In general terms, the actuating element 7 of the elevator car 1 moves the load space floor relative to the sliding carriage 2 in such a way that, after activating the service brake 8, the load space floor 6 has an offset to the building floor bottom 14 of at most ten millimeters. Preferably, the position of the load space floor 6 is regulated in such a way that no offset occurs between the load space floor 6 and the building floor bottom 14.

FIG. 2 to FIG. 5 show further exemplary embodiments for the realization of an elevator car 1 according to the invention which differ in particular in the type of arrangement of the actuating element 7.

In the exemplary embodiment of an elevator car 1 shown in FIG. 2, only one damping element 9 is provided, for example, which is connected in series with the actuating element 7. For example, it is provided here that the damping element 9 is arranged on the actuating element 7, for example a pneumatic lifting piston. In particular, it is provided as an advantageous variant to this embodiment that the damping element 9 and the actuating element 7 are realized by an actively adaptive damping element 10, especially an MRT damper.

In the exemplary embodiment of an elevator car 1 shown in FIG. 3, damping elements 9 are arranged beneath the load space 5, for example four damping elements. Furthermore, the elevator car 1 in the exemplary embodiment shown in FIG. 3 comprises at least two actuating elements 7, for example actuating elements which are height-adjustable by means of electrically operated worm gears. The actuating elements 7 are arranged beneath a plate forming the load space floor 6 between the load space floor 6 and the load space 5.

FIG. 4 shows a further variant embodiment of an elevator car 1 according to the invention, in which the damping elements 9 are likewise arranged beneath the load space 5. The actuating element 7 of the elevator car 1, on the other hand, is arranged between the sliding carriage 2 and the receiving means 4 of the elevator car 1 in such a way that it allows a tilting movement of the receiving means 4 and thus also of the load space floor 6. In this case, by means of the actuating element 7, such as a movable rack, in the area where the actuating element 7 is arranged, the distance between the sliding carriage 2 and the receiving means 4 is increased or decreased depending on the actuation of the actuating means 7. For this purpose, the receiving means 4 is swivel-mounted accordingly on the sliding carriage 2 in the upper region of the receiving means 4.

FIG. 5 shows in top view a cutout of a further exemplary embodiment of an elevator car 1 designed according to the invention. A service brake 8 is arranged on the sliding carriage 2 of the elevator car 1. The service brake 8, when activated, is designed to be brought into engagement with a guide rail of an elevator installation and to hold the elevator car 1 immovably on the guide rail with the service brake activated.

Arranged between the sliding carriage 2 and the service brake 8 in this exemplary embodiment is an actuating element 7. The actuating element 7 enables a lowering or raising of the sliding carriage 2 and thus also of the load space floor, not shown in FIG. 5, with respect to the service brake 8 arranged on the sliding carriage 2. In this way, during a building floor stop, an offset between the load space floor and the building floor bottom can be advantageously regulated so that it does not become larger than ten millimeters.

Making reference to FIG. 6 and FIG. 7, an exemplary embodiment shall be described for a proposed method for operating an elevator installation. FIG. 7 shows an enlarged cutout of FIG. 6. In particular, it is provided that such a method for operating an elevator installation is carried out by means of a control system of the elevator installation. The control system in particular is a decentralized control system, wherein one or more control units are provided for example for the assigning of elevator cars 1 to corresponding calls from people who want to be transported. In particular, it is provided that destination calls made by people are detected by means of a destination call control system and suitable elevator cars are assigned to these calls to handle the respective call. In this process, the elevator cars 1 are moved by a linear motor drive along guide rails 3 of the elevator installation. The respective guide rail forms the primary part of the linear motor and the sliding carriage 2 of a respective elevator car 1 forms the secondary part of the linear motor. Basically, it may also be provided as a variant embodiment that the guide rail 3 forms the secondary part and the sliding carriage 2 comprises the primary part. Arranged on the sliding carriage 2 of an elevator car 1 of the elevator installation is a receiving means 4, which supports a load space 5 configured as a cabin. Arranged between the receiving means 4 and the load space 5 are damping elements 9, by means of which the load space 5 is vibration-related decoupled from the sliding carriage 2.

The load space floor 6 of an elevator car 1 of the elevator installation is a plate arranged in the load space 5, connected across actuating elements 7 to the load space 5. The actuating elements 7 may be actuated by a closed-loop control device 11 of the respective elevator car 1, which is part of the control system in the exemplary embodiment. Now, if such an elevator car 1 is supposed to pick up people at a building floor 13, the elevator car will move to the corresponding building floor 13, especially making use of the control system of the elevator installation. The elevator car 1 will be moved by means of the linear motor drive to the building floor 13 in particular in such a way that, upon halting of the elevator car 1, no offset 12 is formed between the load space floor 6 and the building floor bottom 14. The service brake 8 of the elevator car 1 will then be activated and the elevator car 1 will be held by the activated service brake 8 in the position in which the elevator car 1 was halted. The linear motor drive for this elevator car 1 is then advantageously deactivated in order to reduce the energy consumption.

The access from the load space 5 to the building floor 13 is then freed up, in particular by opening corresponding cabin doors of the load space (not explicitly shown in FIG. 6 and FIG. 7) and corresponding shaft doors of the particular shaft of the elevator installation (also not explicitly shown in FIG. 6 and FIG. 7). By virtue of the fact that people exit from the load space 5 during the building floor stop and/or people enter the load space 5 during the building floor stop, the payload of the load space 5 changes. Since the load space 5 is arranged via the damping elements 9 on the receiving means 4, the damping elements have the effect of pushing the load space 5 upward when the payload decreases, especially by several millimeters or even up to several centimeters, or the load space 5 is pushed downward when the payload increases, especially by several millimeters or even up to several centimeters, which would result in a change in the offset 12 between the load space floor 6 and the building floor bottom 14.

This change in the offset 12 is counteracted by the closed-loop control device 11 by actuating the actuating elements 7. Thus, by means of appropriate sensors, a change in the offset 12 is detected and the detected data is transmitted to the closed-loop control device 11. The closed-loop control device 11 responds to changes in the offset 12 at a building floor stop with corresponding actuation of the actuating elements 7. By means of the actuating elements 7 of the elevator car 1, the load space floor 6 is moved relative to the sliding carriage 2 and thus also relative to the building floor bottom 14 in such a way that the change in the offset 12 is counteracted, in particular in such a way that the load space floor 6 has an offset 12 to the building floor bottom 14 of at most ten millimeters. Preferably the offset 12 is held constant by means of the closed-loop control device 11.

If the load space 5 thus drops down due to an increase in the payload, the actuating elements 7 will be actuated such that they perform an upward lifting movement and thereby raise the load space floor 6. On the contrary, if the load space 5 is lifted up by a decrease in the payload, the actuating elements 7 will be actuated such that they perform a downward stroke movement and thereby lower the load space floor 6.

Once the people have gotten in or gotten out accordingly, the shaft doors and the cabin doors of the elevator car 1 will be closed. In particular, the closed doors may be triggers for ending the regulation of the offset. Accordingly, an opening of the doors at a building floor stop may be the start of the regulation of the offset.

The linear motor drive for the elevator car 1 is once more activated in the exemplary embodiment after the closing of the doors and the service brake 8 is deactivated. The elevator car 1 is then moved further along the guide rails 3 to handle the next call.

Making reference to FIG. 8, an exemplary embodiment shall be explained for the regulation of the offset 12 with the aid of a block diagram. Here, the closed-loop control device 11 is assigned as a command variable 16, for example, that the load space floor 6 during a building floor stop should be free of offset to the building floor bottom 14. For this purpose, the closed-loop control device 11 actuates the at least one actuating element 7 of the elevator car 1 with a suitable manipulated variable 17. The at least one actuating element 7 then acts by means of the correspondingly adapted manipulated variable 17′ on the load space floor 6, especially by a negative lifting movement or a positive lifting movement. A payload change 18 on the load space floor acts as a disturbance variable. The resulting offset 12, which of course may also be 0, is returned accordingly in order to determine a control deviation.

The exemplary embodiments represented in the figures and explained in connection with them serve to explain the invention and are not limiting of it. In particular, the representations are not true to scale. For reasons of better clarity, a highly detailed representation of the figures has not been provided.

### LIST OF REFERENCE NUMBERS

1 Elevator car
2 Sliding carriage
3 Guide rail
4 Receiving means
5 Load space
6 Load space floor
7 Actuating element
8 Service brake
9 Damping element
10 Actively adaptive damping element
11 Closed-loop control device
12 Offset
13 Building floor
14 Floor bottom/Building floor bottom
15 Roller
16 Command variable
17 Manipulated variable
18 Payload change

1.-16. (canceled)

17. An elevator car comprising:
a sliding carriage for moving the elevator car along guide rails of an elevator installation configured as part of a linear motor;
a receiving means disposed on the sliding carriage, which receiving means supports a load space having a load space floor, wherein the load space is vibration-related decoupled from the sliding carriage; and
a controllable actuating element configured such that when activated the controllable actuating element enables a relative movement of the load space floor to the sliding carriage or configured such that when activated the controllable actuating element enables a relative movement of the load space floor to a service brake disposed on the sliding carriage.

18. The elevator car of claim 17 wherein the controllable actuating element enables a lifting movement or a tilting movement or a lifting-tilting movement as the relative movement.

19. The elevator car of claim 17 comprising a first damping element by way of which the load space is vibration-related decoupled from the sliding carriage, wherein
the first damping element is disposed between the load space and the receiving means,
the first damping element is disposed between the receiving means and the sliding carriage, or
the first damping element is disposed between the load space and the receiving means and a second damping element is disposed between the receiving means and the sliding carriage.

20. The elevator car of claim 19 wherein the first damping element and the controllable actuating element are realized by an actively adaptive spring damping element.

21. The elevator car of claim 19 wherein the controllable actuating element and the first damping element are connected in series.

22. The elevator car of claim 17 wherein the controllable actuating element is at least one of mechanically adjustable, hydraulically adjustable, pneumatically adjustable, electrically adjustable, or electromechanically adjustable.

23. The elevator car of claim 17 wherein the controllable actuating element is disposed at least one of
between the sliding carriage and the receiving means,
between the load space and the receiving means,
between the load space floor and the load space, or
between the sliding carriage and a service brake disposed on the sliding carriage.

24. The elevator car of claim 17 comprising a closed-loop control device configured to determine an offset between the load space floor and a reference level outside the elevator car and configured to control a position of the load space floor by actuating the controllable actuating element to reduce the offset.

25. An elevator installation comprising:
a shaft that joins together building floors;
a guide rail disposed in the shaft, which guide rail is configured as part of a linear motor; and
an elevator car configured to travel along the guide rail, wherein the elevator car comprises
a sliding carriage for moving the elevator car along the guide rail,
a receiving means disposed on the sliding carriage, which receiving means supports a load space having a load space floor, wherein the load space is vibration-related decoupled from the sliding carriage, and
a controllable actuating element configured such that when activated the controllable actuating element enables a relative movement of the load space floor to the sliding carriage or configured such that when activated the controllable actuating element enables a relative movement of the load space floor to a service brake disposed on the sliding carriage.

26. The elevator installation of claim 25 comprising a closed-loop control device configured to determine an offset between the load space floor and a floor bottom of one of the building floors and configured to control a position of the load space floor by actuating the controllable actuating element to reduce the offset.

27. A method for operating the elevator installation of claim 25, the method comprising:
moving the elevator car along the guide rail with the linear motor between the building floors, wherein the load space is vibration-related decoupled from the sliding carriage at least during movement of the elevator car;
activating the service brake to hold the elevator car stationary on the guide rail when the elevator car stops at one of the building floors with a floor bottom; and
moving via the controllable actuating element the load space floor relative to the sliding carriage or the service brake disposed on the sliding carriage such that the load space floor has an offset to the building floor bottom of at most ten millimeters.

28. The method of claim 27 wherein the load space floor is moved such that the load space floor has the offset to the building floor bottom of at most ten millimeters after activating the service brake but before freeing up access from the load space to the one of the building floors.

29. The method of claim 27 wherein the load space floor is moved such that the load space floor has the offset to the building floor bottom of at most ten millimeters after activating the service brake and before, during, and after a payload change.

30. The method of claim 27 comprising holding the offset of the load space floor to the floor bottom constant while the elevator car is stopped at the one of the building floors.

31. The method of claim 27 comprising holding the load space floor free of offset to the bottom floor after activating the service brake while the elevator car is stopped at the one of the building floors.
